(19) United States
(12) Patent Application Publication
(10) Pub. No.: US 2022/0393836 A1
(43) Pub. Date: Dec. 8, 2022

(54) TRANSCEIVER AND CORRESPONDING METHOD

(71) Applicant: Fraunhofer-Gesellschaft zur Foerderung der angewandten Forschung e.V., Munich (DE)

(72) Inventors: Thomas WIRTH, Berlin (DE); Thomas FEHRENBACH, Berlin (DE); Baris GOEKTEPE, Berlin (DE); Sarun SELVANESAN, Berlin (DE); Thomas SCHIERL, Berlin (DE); Cornelius HELLGE, Berlin (DE)

(21) Appl. No.: 17/886,389

(22) Filed: Aug. 11, 2022

Related U.S. Application Data
(63) Continuation of application No. PCT/EP2021/053339, filed on Feb. 11, 2021.

(30) Foreign Application Priority Data
Feb. 12, 2020 (EP) 20157025.6

(51) Int. Cl. H04L 5/00; H04W 76/14; H04W 76/15; H04L 1/18

(52) U.S. Cl. CPC H04L 5/0055; H04W 76/14; H04W 76/15; H04L 1/1812

(57) ABSTRACT

A transceiver including one or more HARQ entities; here, the transceiver is configured to transmit a first data portion by use of a sidelink (to a further transceiver) at a first timeslot and to receive a corresponding feedback portion (indicating the correct or incorrect receipt of the first data portion) at a first subsequent timeslot (one or more timeslots after the first timeslot) within a resource pool using the one or more HARQ entities; the one or more HARQ entities are configured to determine the number of HARQ processes used for a communication with another sidelink transceiver based on transmission parameters.

### CROSS-REFERENCE TO RELATED APPLICATIONS

This application is a continuation of copending International Application No. PCT/EP2021/053339, filed Feb. 11, 2021, which is incorporated herein by reference in its entirety, and additionally claims priority from European Application No. EP 20157025.6, filed Feb. 12, 2020, which is also incorporated herein by reference in its entirety.

Embodiments of the present invention refer to a transceiver comprising one or more HARQ entities, to a UE comprising such a transceiver and to a method for determining a number of HARQ processes. Preferred embodiments refer to a concept called V2X maximum HARQ process number determination. Another embodiment refers to a transceiver comprising one or more HARQ entities.

### BACKGROUND OF THE INVENTION

FIG. 9 is a schematic representation of an example of a terrestrial wireless network 100 including, as is shown in FIG. 9(a), a core network 102 and one or more radio access networks RAN1, RAN2, . . . RANN. FIG. 9(b) is a schematic representation of an example of a radio access network RANn that may include one or more base stations gNB1 to gNB5, each serving a specific area surrounding the base station schematically represented by respective cells 1061 to 1065. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 9(b) shows an exemplary view of five cells, however, the RANn may include more or less such cells, and RANn may also include only one base station. FIG. 9(b) shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. This may be realized on licensed bands or on unlicensed bands.

Further, FIG. 9(b) shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g. via the S1 interface, via respective backhaul links 1141 to 1145, which are schematically represented in FIG. 9(b) by the arrows pointing to “core”. The core network 102 may be connected to one or more external networks. Further, some or all of the respective base station gNB1 to gNB5 may be connected, e.g. via the S1 or X2 interface or the XN interface in NR, with each other via respective backhaul links 1161 to 1165, which are schematically represented in FIG. 9(b) by the arrows pointing to “gNBs”. A sidelink channel allows direct communication between UEs, also referred to as device-to-device (D2D) communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB) and one or more of a system information block (SIB), the physical downlink, uplink and sidelink control channels (PDCCH, PUCCH, PSCCH) carrying for example the downlink control information (DCI), the uplink control information (UCI) and the sidelink control information (SCI). Note, the sidelink interface may support a 2-stage SCI. This refers to a first control region containing some parts of the SCI, and optionally, a second control region, which contains a second part of control information.

For the uplink, the physical channels may further include the physical random access channel (PRACH or RACH) used by UEs for accessing the network once a UE synchronized and obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix (CP) length. A frame may also consist of a smaller number of OFDM symbols, e.g. when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g. DFT-s-OFDM. Other waveforms, like non-orthogonal waveforms for multiple access, e.g. filter-bank multicarrier (FBMC), generalized frequency division multiplexing (GFDM) or universal filtered multi carrier (UFMC), may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 9 may be a heterogeneous network having distinct overlaid networks, e.g., a network of macro cells with each macro cell including a macro base station, like base station gNB1 to gNB5, and a network of small cell base stations (not shown in FIG. 9), like femto or pico base stations.

In addition to the above described terrestrial wireless network also non-terrestrial wireless communication networks (NTN) exist including spaceborne transceivers, like satellites, and/or airborne transceivers, like unmanned aircraft systems. The non-terrestrial wireless communication network or system may operate in a similar way as the terrestrial system described above with reference to FIG. 9, for example in accordance with the LTE-Advanced Pro standard or the 5G or NR, new radio, standard.

It is noted that the information in the above section is only for enhancing the understanding of the background of the invention and therefore it may contain information that does not form conventional technology that is already known to a person of ordinary skill in the art.

In Re1.16 V2X, HARQ has been introduced to support feedback on the sidelink SL channel for device-to-device unicast transmissions. Here, each UE maintains a number of HARQ processes.

For the sidelink communication, there are different approaches, e.g., all properties for the sidelink can be preconfigured, e.g., by the base station or the user equipment have a limited liberty to select the respective properties. The same holds true for the HARQ process to be performed by the respective UEs communicating via sidelink.

### SUMMARY

An embodiment may have a transceiver including one or more HARQ entities; wherein the transceiver is configured to transmit a first data portion by use of a sidelink at a first timeslot and to receive a corresponding feedback portion at a first subsequent timeslot within a resource pool using the one or more HARQ entities; wherein the one or more HARQ entities are configured to determine the number of HARQ processes used for a communication with another sidelink transceiver based on transmission parameters, wherein the transmission parameters include feedback periodicity, minimum time gap between the first and subsequent time slots and/or a timeslot for the retransmission.

Another embodiment may have a further transceiver including one or more HARQ entities, wherein the further transceiver is configured to receive a first data portion by use of a sidelink at a first timeslot and to transmit a corresponding feedback portion at a first subsequent timeslot within a resource pool using the one or more HARQ entities, wherein the one or more HARQ entities are configured to determine the number of the HARQ processes used for a communication with another sidelink transceiver based on transmission parameters or configured grant configuration as part of the transmission parameters; wherein the transmission parameters include feedback periodicity, minimum time gap between the first and subsequent time slots and/or a timeslot for the retransmission.

According to another embodiment, a system may have: at least a transceiver including one or more HARQ entities; wherein the transceiver is configured to transmit a first data portion by use of a sidelink at a first timeslot and to receive a corresponding feedback portion at a first subsequent timeslot within a resource pool using the one or more HARQ entities; wherein the one or more HARQ entities are configured to determine the number of HARQ processes used for a communication with another sidelink transceiver based on transmission parameters, wherein the transmission parameters include feedback periodicity, minimum time gap between the first and subsequent time slots and/or a timeslot for the retransmission, and a further transceiver including one or more HARQ entities, wherein the further transceiver is configured to receive a first data portion by use of a sidelink at a first timeslot and to transmit a corresponding feedback portion at a first subsequent timeslot within a resource pool using the one or more HARQ entities, wherein the one or more HARQ entities are configured to determine the number of the HARQ processes used for a communication with another sidelink transceiver based on transmission parameters or configured grant configuration as part of the transmission parameters; wherein the transmission parameters include feedback periodicity, minimum time gap between the first and subsequent time slots and/or a timeslot for the retransmission.

Another embodiment may have a method for determining the number of HARQ processes for a transceiver, wherein the transceiver is configured to transmit a first data portion by use of a sidelink at a first timeslot and to receive a corresponding feedback portion at a first subsequent timeslot within a resource pool using the one or more HARQ entities, wherein the method includes the step of determining the number of HARQ processes used for a communication with another sidelink transceiver based on transmission parameters; wherein the transmission parameters include feedback periodicity, minimum time gap between the first and subsequent time slots and/or a timeslot for the retransmission.

Another embodiment may have a method for determining the number of HARQ processes for a further transceiver, wherein the further transceiver is configured to receive a first data portion by use of a sidelink at a first timeslot and to transmit a corresponding feedback portion (indicating the correct/incorrect receipt of the first data portion) at a first subsequent timeslot within a resource pool using the one or more HARQ entities, the method including the steps of determining the number of HARQ processes used for a communication with another sidelink transceiver based on transmission parameters; wherein the transmission parameters include feedback periodicity, minimum time gap between the first and subsequent time slots and/or a timeslot for the retransmission.

### BRIEF DESCRIPTION OF THE DRAWINGS

Embodiments of the present invention will be detailed subsequently referring to the appended drawings, in which:

FIG. 1 shows a schematic block diagram of a transceiver, e.g., the transceiver of a user equipment having one or more HARQ entities according to basic embodiments;

FIG. 2 shows a schematic diagram illustrating the relation between HARQ RTT (round trip time) and a number of HARQ processes;

FIG. 3 shows a schematic diagram for illustrating the PSFCH periodicity and feedback periodicity as configured by period PSFCH resources equal (0, 1, 2, 4) slots in accordance to embodiments;

FIG. 4 shows schematically the communication between two transmitters and one receiver by use of sidelink communication according to embodiments;

FIG. 5 schematically shows the minimum time gap between PSFCH and associated PSSCH in slot;

FIG. 6 shows schematically a maximum SL roundtrip time and resulting high processes according to embodiments;

FIG. 7 shows schematically the SL roundtrip time with minimum time gap of 2 and periodic PSFCH of one according to an embodiment;

FIG. 8a-b shows schematically confutation data according to an embodiment;

FIG. 9a-b schematically shows a representation of an example of a terrestrial wireless network; and

FIG. 10 shows a schematic representation of a computer system.

### DETAILED DESCRIPTION OF THE INVENTION

Below, embodiments of the present invention will subsequently be discussed referring to the enclosed figures, wherein similar or identical reference numbers are provided to options having similar or identical functions, so that the description thereof is mutually applicable and interchangeable.

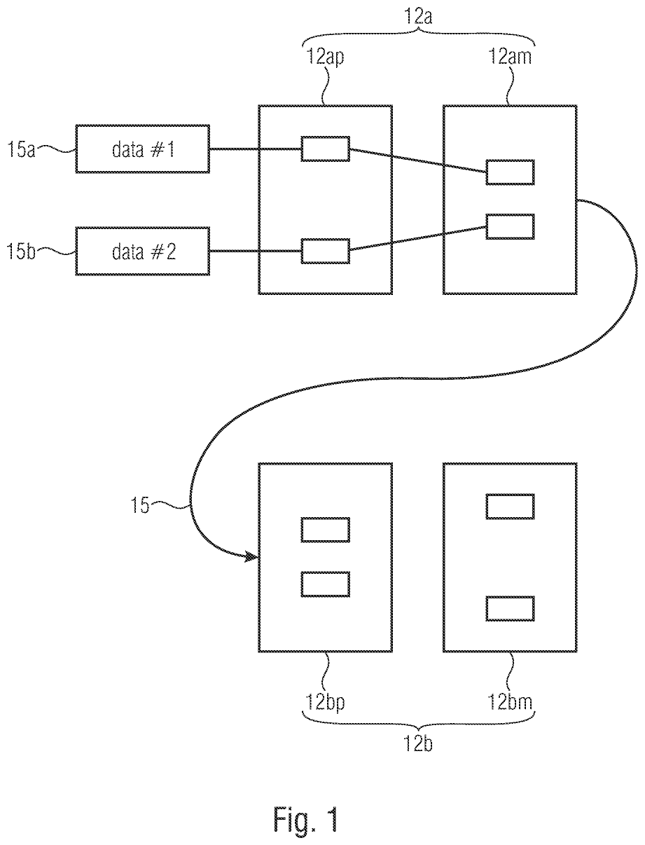

Before discussing the approach according to embodiments in detail taking reference to FIG. 1, the problem and the proposed solution according to basic embodiments will be discussed.

As already mentioned before, HARQ has been introduced to support feedback on the sidelink channel for device-to-device unicast transmission. The UE maintains a number of HARQ processes. An incoming transmission in a slot is assigned to a HARQ process. For this purpose, each Sidelink Control Information (SCI) contains a HARQ process ID which identifies to which HARQ process this specific data transmission, via Physical Sidelink Shared Channel (PSSCH), belongs to. Due to the fact that a UE would not transmit more than a single PSSCH in a given slot to the same UE, the number of needed HARQ processes is determined by the HARQ round-trip time (RTT) as well as the (success or) failure of transmission of the particular data, see FIG. 1. By use of a HARQ entity which performs a determination of the number of HARQ processes, same can be dynamically adapted.

According to embodiments, the MAC entity includes at most one sidelink HARQ entity for transmission on SL-SCH, which maintains a number of parallel sidelink processes.

Transceiver and UE

According to basic implementation, a transceiver comprising one or more HARQ entities is used. The transceiver is configured to transmit a first data portion by use of a sidelink (to a further transceiver) at a first timeslot and to receive a corresponding feedback portion (indicating the correct or incorrect receipt of the first data portion) at a first subsequent timeslot (one or more timeslots after the first timeslot) within a resource pool using a HARQ entity. Here, the one or more HARQ entities are configured to determine the number of HARQ processes used for a communication with another sidelink transceiver based on transmission parameters.

According to embodiments, the communication with another sidelink transceiver is identified using one or more source id, destination id and/or cast type (e.g., unicast or groupcast).

According to embodiments, the transition parameters based on which the determination of the number of HARQ processes is performed, can comprise one or more resource pool parameters, or parameters extracted from the resource pool configuration. The transmission parameters may indicate a configured grant configuration.

According to embodiments, the maximum number of transmitting sidelink processes associated with the sidelink HARQ entity may be limited, e.g. maybe 16. A sidelink process may be considered for a transmission of multiple MAC-PDUs. For transmissions of multiple MAC-PDUs with sidelink resources allocation mode 2, the maximum number of transmitting sidelink processes associated with the sidelink HARQ entity may be 4. This maximum number may be a resource pool parameter or parameter extracted from the resource pool configuration.

Below, possible parameters will be discussed. According to embodiments, the SR-TX pool schedule may be performed using the SL-BWP-Tool-Config field. For example, the SL-TX pool scheduling indicates the resources by which the UE is allowed to transmit NR sidelink communication based on network scheduling on the configured BWP. For the PSFCH-related configuration, if configured, will be used for PSFSCH transmission/reception. According to a further embodiment, the SL-TX pool selected normal indicates the resources by which the UE is allowed to transmit NR sidelink communication by a UE autonomous resource selection on the configured BWP. For the PSFCH-related configuration, if configured, will be used for the PSFSCH transmission/reception. According to further embodiments, the SL-configured grant configured field description may be used as follows: SL-NROFHARQ-processes may be supported. This field indicates a number of HARQ processes configured for a specific configuration grant. It applies to both, type 1 and type 2.

Embodiments of the present invention are based on the principle that the number of HARQ entities can be determined or calculated based on known parameters used for transmission, e.g., a feedback periodicity or a minimum time gap between the first and subsequent time slots. Another parameter which may have an influence is the minimum time gap between the first subsequent time slot (within which the ACK/NACK can be received) and a timeslot for the retransmission. These above discussed parameters determine the so-called roundtrip time of the entire HARQ process. In order to insure that each data belonging to a timeslot within one entire roundtrip time can be buffered, the number of HARQ processes are adapted to this roundtrip time. Based on parameters given by a resource pool configuration, the minimum timegap, feedback processing time and feedback periodicity can vary. Therefore, also the roundtrip time and thus the number of (needed) HARQ processes vary, too. By knowing the needed number of HARQ processes, it is possible to dynamically adapt the number of HARQ processes which is used by the HARQ entity.

Thus, according to embodiments, the transceiver performs the retransmission of the first data portion at a first retransmission time slot or at a first retransmission timeslot after the first subsequent timeslot. According to embodiments, the HARQ entity is configured to buffer the first data portion and/or further data portions and/or to retransmit the first data portion or a further data portion upon a respective feedback portion indicating an incorrect receipt of the first data portion.

According to further embodiments, the number of HARQ processes is determined based on wherein the number of HARQ processes is determined on a roundtrip time of the entire HARQ process for one data portion. The roundtrip time or and, thus, the number of HARQ processes may be determined the following formula

T_{RTT}=T_{minRX}+P_{PSFCH}, wherein T_{minRX} corresponds to the minimum time gap between the first time slot and the first subsequent time slot and data portion, wherein P_{PSFCH} corresponds to the feedback periodicity. Alternatively, based on the formula T_{RTT}=T_{minRX}+P_{PSFCH}+T_{feedbackprocessing}, wherein T_{minRX} corresponds to the minimum time gap between the first time slot and the first subsequent time slot and data portion, wherein P_{PSFCH} corresponds to the feedback periodicity and where T_{feedbackprocessing} is the minimum time gap between the first subsequent time slot and a time slot for the retransmission.

According to embodiments, the number of data packets to be stored by the HARQ entity depends on the number of HARQ processes. According to embodiments, the HARQ entity may be configured to determine the number of HARQ processes used to identify a data portion for a communication with another sidelink transceiver (e.g. S_[H-ID]=ceil(log 2(N_[H-Processes])). According to embodiments, the number of HARQ processes depends on the number of timeslots between the first timeslot and the first subsequent timeslot.

According to embodiments, the number of HARQ processes is limited, e.g. by seven or eight as default; alternatively, the transceiver is configured to transmit a second data portion by use of a sidelink at a second timeslot and to receive a corresponding feedback portion at a second subsequent timeslot. According to embodiments the number of HARQ processes is limited by, e.g. 4 or 16, based on a transmission parameter.

According to embodiments, the transceiver according to one of the previous claims, wherein the transceiver is configured to transmit a second data portion by use of a sidelink at a second timeslot and to receive a corresponding feedback portion at a second subsequent timeslot. According to further embodiments, the transceiver may be configured to transmit a further first data portion by use of a further (parallel) sidelink (to another further transceiver) and to receive a further corresponding feedback portion (indicating the correct/incorrect receipt of the further first data portion).

According to embodiments, the one or more HARQ entities having no available HARQ process overwrites/flushes an existing HARQ process. For example, the buffer to be overwritten/flushed is chosen by one or more of:
Lowest priority of a packet,
Source and/or destination ID,
Cast type,
Associated logical channel (LCH) or QoS flow,
Age of a data portion (e.g. delete oldest first)
Remaining packet delay budget,
Number of retransmissions,
Buffer size, e.g. delete large packet to free-up more soft buffer
e.g. transmission with many retransmissions (each retransmission also occupies soft-buffer).

Another embodiment provides a further transceiver, e.g., the receiver. This further transceiver also comprises one or more HARQ entities. The further transceiver is configured to receive a first data portion by use of a sidelink (from a transceiver) at a first timeslot and to transmit a corresponding feedback portion (indicating the correct/incorrect receipt of the first data portion) at a first subsequent timeslot within a resource pool using the one or more HARQ entities. Here, the one or more HARQ entities are configured to determine the number of the HARQ processes used for a communication with another sidelink transceiver (transmitter) based on transmission parameters.

A method for determining the number of HARQ processes for a further transceiver, wherein the further transceiver is configured to receive a first data portion by use of a sidelink (from a transceiver) at a first timeslot and to transmit a corresponding feedback portion (indicating the correct/incorrect receipt of the first data portion) at a first subsequent timeslot, the method comprising the steps of determining the number of HARQ processes based on a transmission parameter.

The above-discussed transceivers are the basic implementation. According to further embodiments, a user equipment comprising the transceiver or the further transceiver is needed.

System

Another embodiment refers to system comprising at least a transceiver and the further transceiver as defined above.

Method

Another embodiment provides a method for determining the number of HARQ processes for a transceiver. The transceiver is configured to transmit a first data portion by use of a sidelink (to a further transceiver) at a first timeslot and to receive a corresponding feedback portion (indicating the correct or incorrect receipt of the first data portion) at a first subsequent timeslot (one or more timeslots after the first timeslot) within a resource pool using the one or more HARQ entities, wherein the method comprises the step of determining the number of HARQ processes used for a communication with another sidelink transceiver based on transmission parameters.

Another embodiment provides a method for determining the number of HARQ processes for a further transceiver. The further transceiver is configured to receive a first data portion by use of a sidelink (from a transceiver) at a first timeslot and to transmit a corresponding feedback portion (indicating the correct/incorrect receipt of the first data portion) at a first subsequent timeslot within a resource pool using the one or more HARQ entities, the method comprising the steps of determining the number of HARQ processes used for a communication with another sidelink transceiver based on transmission parameters.

According to further embodiments, the method can be computer implemented.

Implantation According to Further Embodiments

Since now the basic implementations according to embodiments have been discussed, further details regarding the implementation will be given taking reference to the enclosed figures.

FIG. 1 shows two transceivers 10a and 10b, e.g., of a user equipment having a connection 15. As illustrated, data should be transmitted from the transceiver 10a/transmitter 10a to the transmitter 10b/receiver 10b. Here, two exemplarily data packets 15a and 15b are illustrated. These data packets 15a and 15b are transmitted to the receiver 10b, wherein the parallel HARQ processing is performed by use of the HARQ entity 12a. For example, the data packets 15a, 15b can be transmitted subsequent to each other using different time. The HARQ entity 12a may comprise a processor 12ap and a memory 12am for buffering the data packets 15a and 15b to be transmitted. Analogously, the receiver 10b comprises the same entities 12bp and 12bm. The processor 12ap maps the data packets 15a and 15b to be transmitted to respective memory portions of the memory 12am. The number of data portions to be buffered or the number of parallel HARQ processes for one transmission 15 is typically preconfigured. Here, it might amount to 8 (worse case parameter).

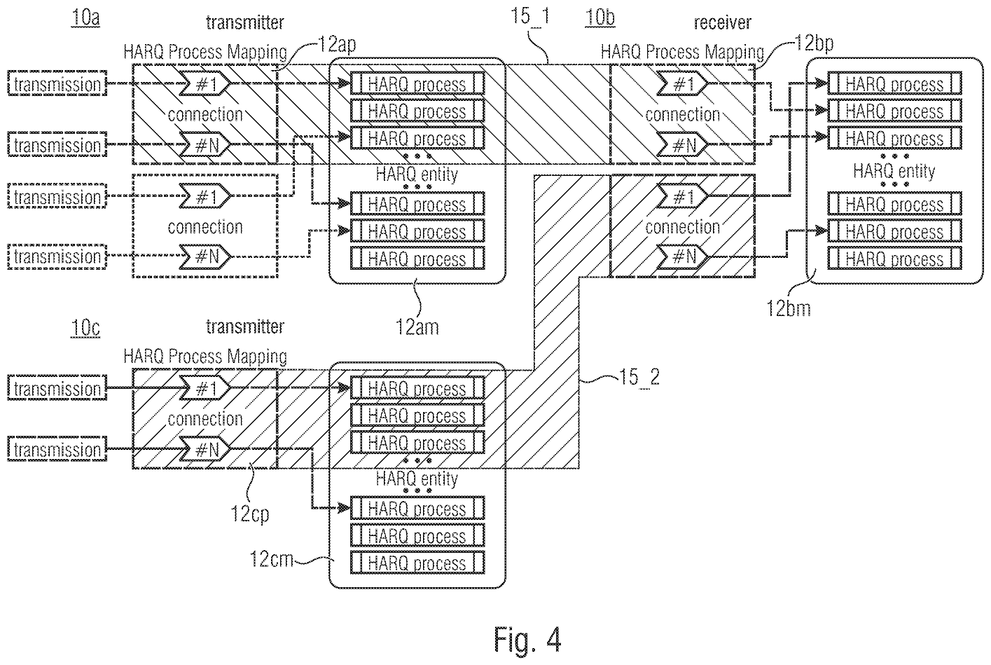

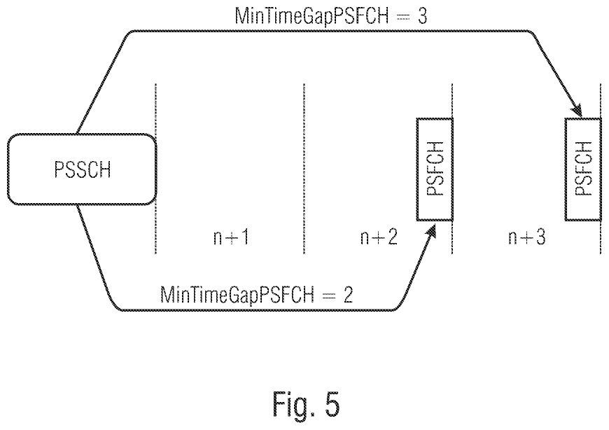

In order to perform this HARQ processing more dynamically so that for parallel transmissions the same entity 12am can be used without increasing its size (cf. FIG. 4), the number of HARQ processes should be reduced as much as possible, e.g., to a number which is the minimum needed number.

Just for the sake of completeness, it should be noted that the respective HARQ entity, e.g., the HARQ entity 12b analyzes the received data 15 in order to determine a correct/incorrect, complete/incomplete receipt of the data 15. For example, in case of a correct receipt, it transmits an ACK to the transceiver 10a, wherein in place of an incorrect receipt, it transmits a NACK to the transceiver 10a. The HARQ entity 12a of the transceiver 10a receives this ACK/NACK and performs, e.g., in case of a NACK (non-acknowledgement), a retransmission of the buffered data from the memory 12m.

It was agreed that only one HARQ entity is maintained for each of the sidelink carriers for reception i.e., the HARQ processes are shared between connections. This can lead to a shortage of HARQ processes on the receiver side when several transmitters occupy the HARQ processes at the same time. Furthermore, the introduction of up to 32 retransmissions exacerbates this problem, as the HARQ processes can be occupied for a longer time. To mitigate these issues, one of the methods would be to limit the maximum number of HARQ processes per link. As discussed above, the maximum number of transmitting sidelink processes associated with the sidelink HARQ entity may be limited, for example to 16 or, for example, to 4. According to embodiments the limitation may dependent on different modes. For example. Mode 1 can configure up to 16 HARQ processes in a configured grant config, where M2 only supports 4 transmitting HARQ processes.

In order to determine the minimum/recent/needed number of HARQ processes, the HARQ entity 12a determines the number of HARQ processes used for communication with another sidelink transceiver 12b based on transmission parameters.

Examples of these transmission parameters are the periodicity of the respective receipt command, i.e., of the ACK/NACK. This ACK/NACK can be transmitted by use of a separate physical control channel or within the same channel within which the transmission 15 is/has been performed. For example, within certain periodic resource portions, the ACK/NACK can be received. In this periodicity, is or may be used as parameter for determining the number of HARQ processes. This can parameter may be referred to as periodPSFCHresource. Another parameter is the minimum time gap between the transmission and the possibility that the receiver reacts. For this minimum time gap, the process performance of the receiver 10b or especially of the HARQ entity 12b of the receiver 10b and the transmission time is relevant. Background thereof is that the analysis of the received data can just start after some time frames and also have a certain duration. This parameter is referred to as MinTimeGapPSFCH. These two parameters periodPSFCHresource at MinTimeGapPSFCH are typically parameters defined by the RP configuration. This means that the RP configuration can include
periodPSFCHresource (0, 1, 2, 4)
   The periodicity of PSFCH in slots, see FIG. 3

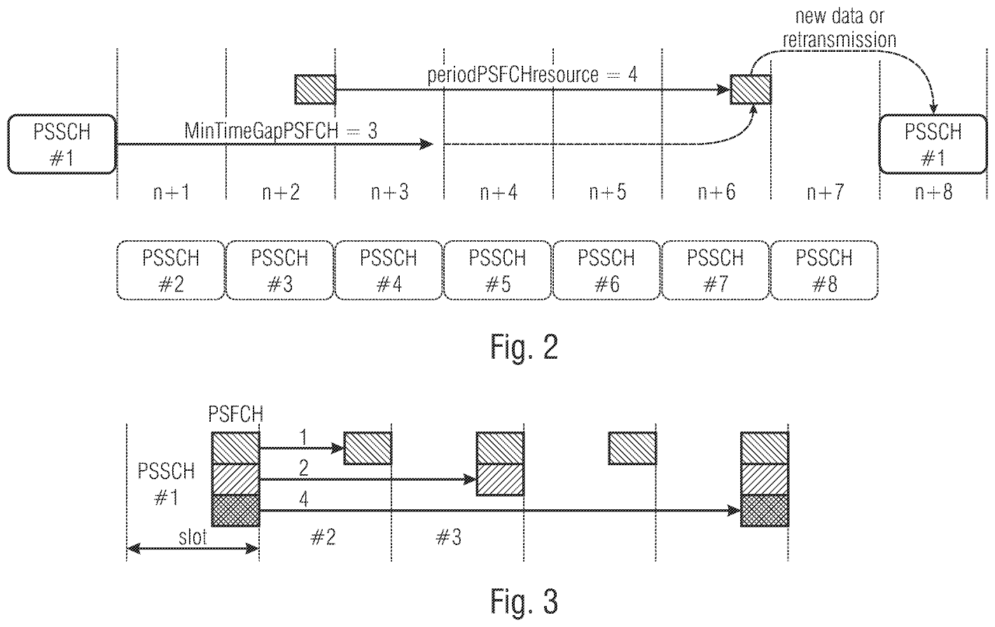

FIG. 3 shows, for example, for the periodicity is configured by periodPSFCHresources. Within the first line, a periodicity of 1 is illustrated. This means that after each PSFCH timeframe, e.g., number 1, another timeframe, e.g., number 2 follows within which the PSFCH for the previous timeframe is transmitted. As illustrated within the second row, there is at least one timeframe . . . . This means that for PSSCH number 1, that PSFCH is followed within the timeframe number 3. For a periodicity of 4, this principle is illustrated in the last column. Of course, there is also the option that the periodicity of 0 is enabled. Here, the PSFCH is transmitted within the same timeslot
MinTimeGapPSFCH (2, 3)
   Minimum gap between a PSSCH and corresponding PSFCH, see FIG. 2.

FIG. 2 illustrates the relation between HARQ 1 to a time and a number of HARQ processes. Here, a first PSSCH (#1) is illustrated together with the minimum time gap PSFCH 3 (earliest possible feedback slot) and the periodicity of 4. As can be seen, due to the periodicity just a reformed slot, here n+2 and n+6 the PSFCH is enabled. When starting from number 1, the first feedback can be received at the timeslot m+6/#7 due to the minimum timegap and the periodicity. There is a third factor of influence, namely the processing time for the retransmission. Here, two slots as illustrated by the error new data of retransmission.

Dependent on the position of the PSSCH and the position of the periodic PSFCH, the number of HARQ processes can be reduced from n+8, e.g., if the minimum timegap and the first possible PSFCH according a periodicity fall into the same timeslot. For example, when starting from PSSCH number 3, for example, the number of HARQ processes can be reduced by 2. For PSSCH number 4, the number of HARQ processes can be reduced by 3 since then the error for the minimum timegap and for the periodPSFCHresource point to the same timeslot.

This process is of course done for the subsequent timeframes PSSCH #2, PSCH #3 and so on. As discussed above, for each of the HARQ processes belonging to the respective PSSCH the number can vary. Thus, the number of processes can dynamically be adapted.

This information can be extracted from the RP configuration. Here, a mapping of the number of HARQ processes, i.e., the number of bits in the SCI for the HARQ processes RD, to the RP configuration can be performed. For example, this may be done based on a HARQ RTT (roundtrip time).

The HARQ RTT is determined by the following formula:

T_{RTT}=MinTimeGapPSFCH+periodPSFCHresource+FeedbackProcessing,

where the first two parameters are given in the RP configuration and the FeedbackProcessing can be implicitly assumed to be a certain value by the BS or is preconfigured or configured explicitly by the BS.

The number of needed HARQ processes is equal to the HARQ RTT, hence

T_{HARQprocesses}=T_{RTT}.

According to embodiments, the number of (needed) HARQ processes depends on their resource pool configuration. Here, the resource pool configuration can, for example, be provided by the BS (base station). A resource pool is defined within the sidelink carrier.

According to another option, the roundtrip time can be calculated as follows:

T_{RTT}=T_{minRX}+P_{PSFCH}

where, T_{minRX} corresponds to the minimum time gap between PSSCH and PSFCH (MinTimeGapPSFCH). P_{PSFCH} corresponds to the PSFCH feedback resource periodicity (period PSFCHresource).

When calculating the roundtrip time based on one of the above formulas, it is possible to determine the number of HARQ processes. Here, the roundtrip time may be calculated by the unit timeslots wherein each timeslot involves a HARQ process, i.e., a memory for buffering the data. For example, in case less or equal to 4 HARQ processes are needed, it is sufficient to use two bits for the HARQ process ID in the SCI. In case 5-8 HARQ processes are needed, three bits are sufficient and so on and so forth.

In addition, the maximum number of HARQ processes can be configured to be 2^{N} where N is 1, 2, 3 or 4. When the round trip time is shorter, not all HARQ processes will be used or the transmitter has more scheduling freedom using the remaining available HARQ processes for new data before scheduling a retransmission.

Starting from this, an implementation may be as follows:
Using of different 2^{nd} stage SCI formats
In order to avoid the wastage of bits, different 2^{nd} stage SCI formats can be used, where in each SCI format, the HARQ process ID parameter can correspond to each of the values of N.
Using of same 2^{nd} stage SCI format
The maximum value of N is used for the HARQ process ID parameter. The remaining bits can be used in one of the following ways:
   Padding of unused bits,
   Not utilizing the full value range,
   Using the excess HARQ processes for higher priority transmissions.

Below, some examples for the number of needed HARQ processes dependent on the respective parameters will be given.

This results in a maximum round trip time of

T_{RTT_max}=3 slots+4 slots=7 slots,

when taking a MinTimeGapPSFCH of 3 slots and a periodPSFCHresource of 4 slots. Therefore, the maximum needed number of HARQ processes is 7.

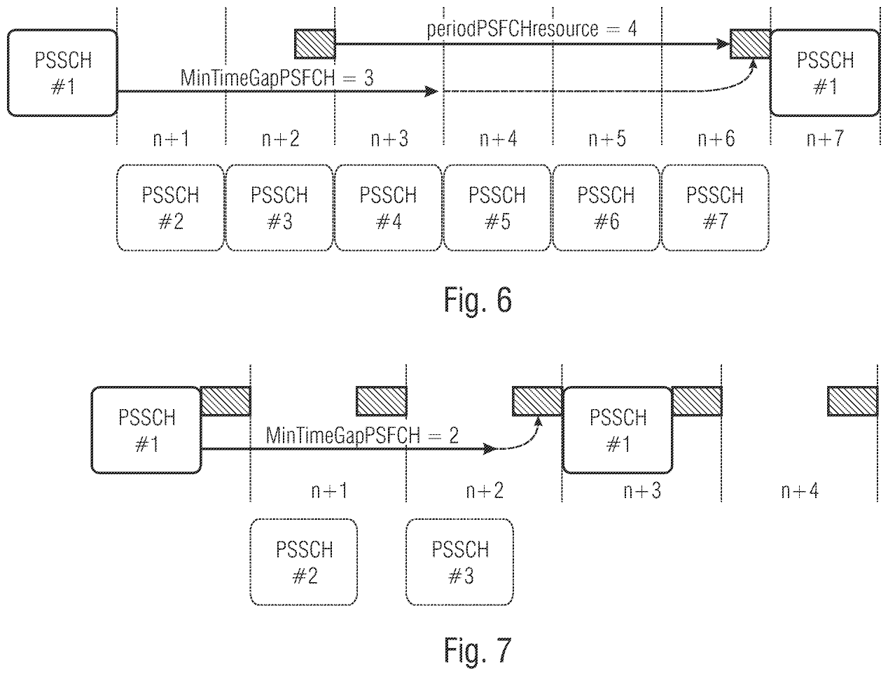

FIG. 6 shows this configuration with the initial transmission of PSSCH with HARQ process number 1 just missing the PSFCH in slot n+2. The feedback is therefore sent in slot n+6 allowing for a reuse of the process in slot n+7.

The UE reusing may for example, for a new transmission, e.g., when a positive feedback is received via PSFCH within the slot n+6 or for a retransmission. Here, the dynamical adaption of the subsequent HARQ processes for PSSCH #2, #3, #4, #5, #6, #7 can be performed as discussed above of the dynamical adaption reduces the entire processing requirements.

As the HARQ process number is signaled in the DCI with N bits, a value 2\hat{ }N should be chosen. Therefore, a suitable candidate for the maximum number of HARQ processes is 8, at least for this embodiment. According to embodiments, the maximum of 7 HARQ processes suffice.

Therefore, as default, 7 HARQ processors or 8 HARQ processes can be set.

Similarly, we can calculate the minimum round trip time and needed number of HARQ processes. This results in a minimum round trip time of

T_{RTT_max}=2 slots+1 slots=3 slots,

when taking a MinTimeGapPSFCH of 2 slots and a periodPSFCHresource of 1 slot. FIG. 7 shows this configuration. Therefore, the minimum needed number of HARQ processes is 3.

Due to the periodicity of 1 within each frame n, n+1, n+2, n+3 a PSFCH resource is shown. It should be noted that the PSFCH resource, e.g., of n+0 is arranged within the subsequent timeslot, i.e., n+1. The error minimum time gap PSFCH equal to 2 illustrates that at least two slots have to be in between the PSSCH and the respective PSFCH resource. In this embodiment This results in a minimum of 4 HARQ processes per connection with N=2 bits. Observation 3: A minimum of 3 HARQ processes per connection are needed.

Based on the above analysis, we propose that the maximum number of HARQ processes per connection should be limited to 8. It is also possible to limit the number of HARQ processes to 4, based on the parameters defined in the resource pool.

Thus according to embodiments, it is possible to limit the maximum number of HARQ processes 28 per connection. According to a further embodiment, it is possible to limit the number of HARQ processors 24, when permitted by the resource pool parameter, i.e., when dynamical determination of the HARQ processes is enabled.

Based on this analysis carried out in this contribution, the following observations and conclusions can be taken. These conclusions can be set as boundaries for the above-discussed determination of the number of HARQ processors.
Observation 1: The number of needed HARQ processes depends on the resource pool configuration.
Observation 2: A maximum of 7 HARQ processes per connection are sufficient.
Observation 3: A minimum of 3 HARQ processes per connection are needed.

Based on the observations, we propose the following:
Limit the maximum number of HARQ processes to 8 per connection.
Limit the number of HARQ processes to 4 when permitted by the resource pool parameters.

According to embodiments, the HARQ entities may activate the dynamic determination/adaption of the number of HARQ processes. This activation signal may be received as part of the resource pool parameters and/or as RRC signaling (radio resource control signaling) from a BS.

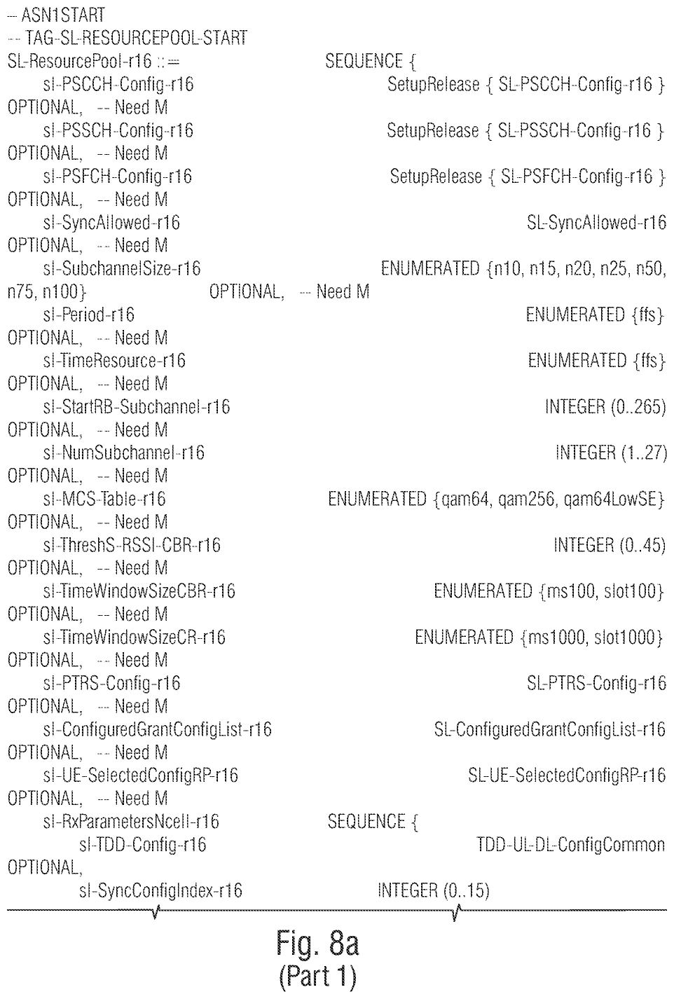

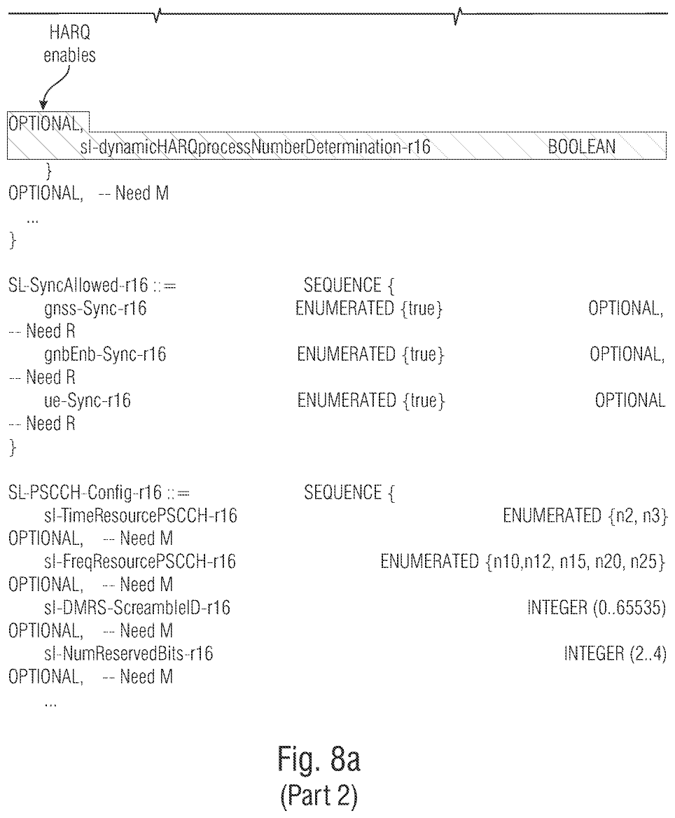

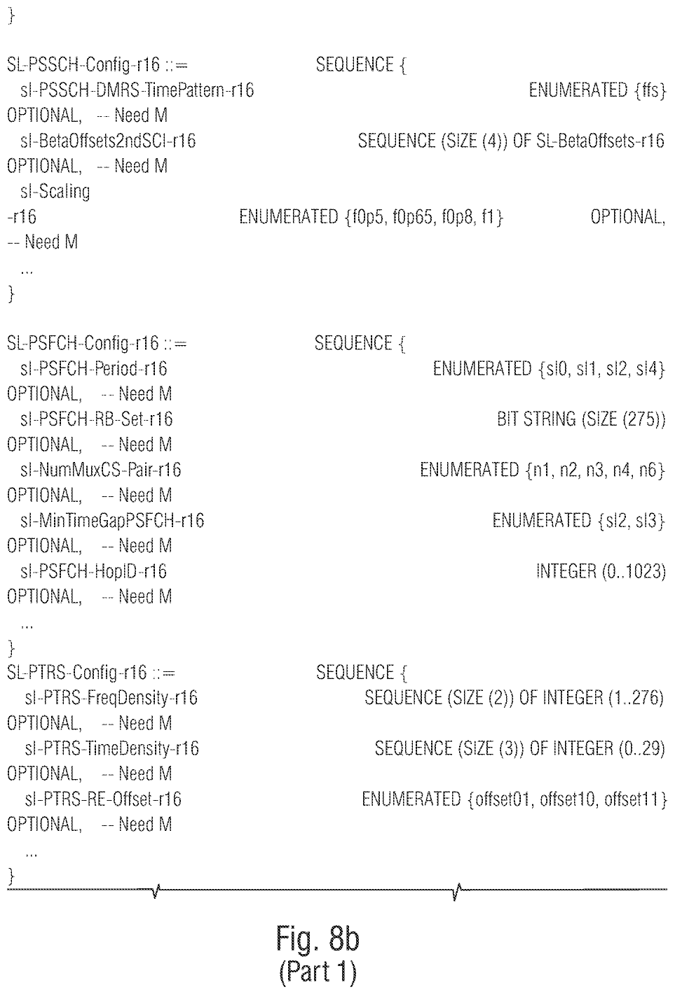

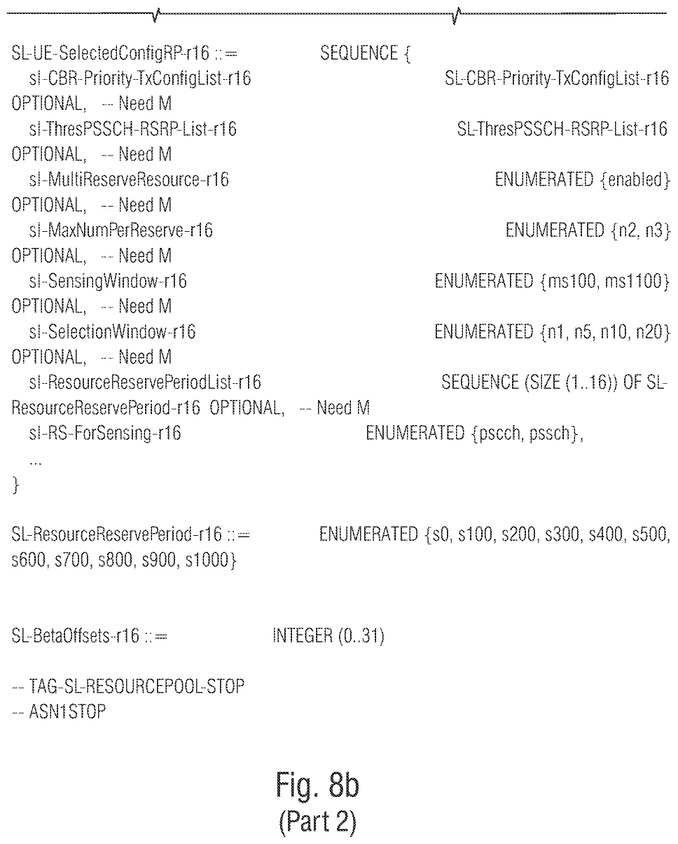

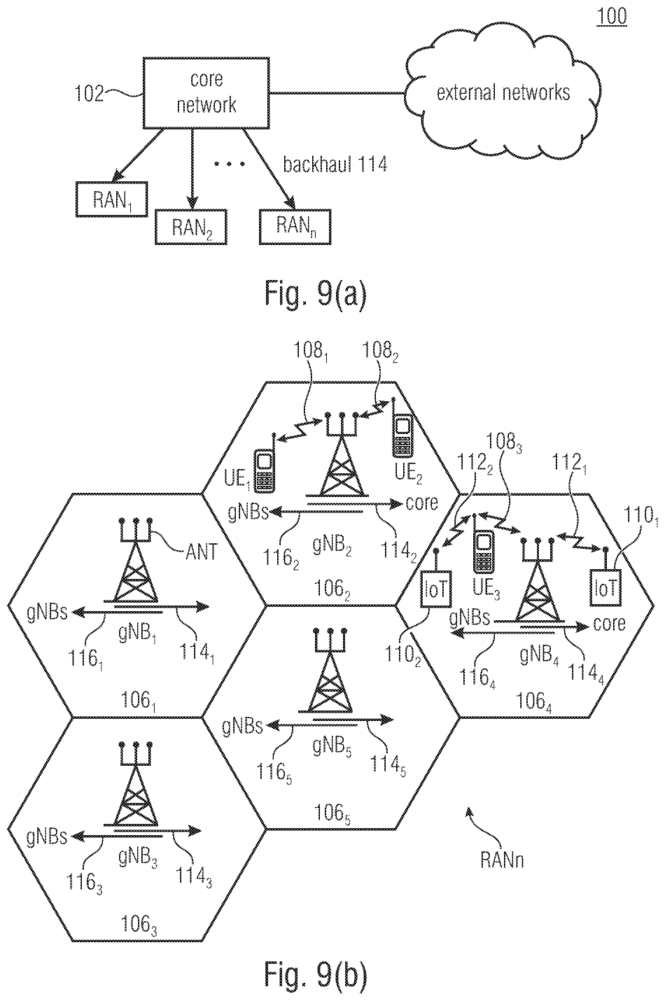

SL Resource Pool RRC configuration: This is the RRC configuration from the current draft to be added to TS 38.331. With respect to FIGS. 8a and 8b an exemplary RRC configuration is shown. The reference numeral HARQ enables the new information element indicating the use of the known procedure of activating the dynamic determination is marked.

Note, that the above-described principle, e.g., the principle discussed in context of FIG. 1 typically refers to one sidelink communication, e.g., between two transceivers of two UEs. Often, but not necessarily per sidelink carrier, one HARQ entity per sidelink carrier is used. Of course, one HARQ entity can be shared for a plurality of sidelink communications performed by the one transceiver in the same sidelink carrier. This is illustrated by FIG. 4.

FIG. 4 shows three transceivers 10a, 10b and 10c, each having the HARQ entity 12am, 12bm, 12cm and a HARQ processing mapping 12ap, 12bp and 12cp. The receiver 10b receives sidelink communication 15_1, 15_2 from the two transmitters 10a and 10c.

Thus, one transceiver 10b, here the receiver, can establish a plurality of sidelink communications 15_1 and 15_2. This receiver 10b comprises at least one HARQ entity which is shared for the two communications 15_1 and 15_2.

The dynamical adaption can, of course, perform for both transmission processors.

According to further embodiments, two HARQ entities can be used for the two transmissions 15_1 and 15_2.

In a further embodiment during PC5 connection setup the use of dynamicHARQprocessNumberDetermination can be negotiated directly between the SL transceivers.

In groupcast the use can be indicated by a group leader.

In accordance with embodiments, the user device, UE, may be one or more of a mobile terminal, or a stationary terminal, or a cellular IoT-UE, or a vehicular UE, or a vehicular group leader (GL) UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity. The base station, BS, may be implemented as mobile or immobile base station and may be one or more of a macro cell base station, or a small cell base station, or a central unit of a base station, or a distributed unit of a base station, or a road side unit, or a UE, or a group leader (GL), or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

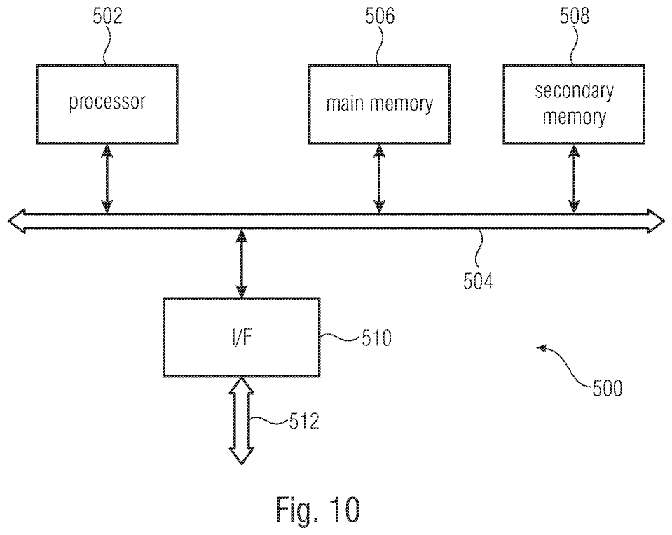

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 10 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the form electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk.

FIG. 10 schematic representation of a computer system.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A transceiver comprising one or more HARQ entities;
wherein the transceiver is configured to transmit a first data portion by use of a sidelink at a first timeslot and to receive a corresponding feedback portion at a first subsequent timeslot within a resource pool using the one or more HARQ entities;
wherein the one or more HARQ entities are configured to determine the number of HARQ processes used for a communication with another sidelink transceiver based on transmission parameters, wherein the transmission parameters comprise feedback periodicity, minimum time gap between the first and subsequent time slots and/or a timeslot for the retransmission.

2. The transceiver of claim 1, wherein the communication with another sidelink transceiver is identified using one or more of source id, destination id and/or cast type (e.g. unicast or groupcast).

3. The transceiver according to claim 1, wherein the transmission parameters comprise one or more resource pool parameters, or parameters extracted from the resource pool configuration.

4. The transceiver according to claim 1, wherein the number of HARQ processes is determined on a roundtrip time of the entire HARQ process for one data portion.

5. The transceiver according to claim 1, wherein the one or more HARQ entities are configured to determine the number of HARQ processes used to identify a data portion for a communication with another sidelink transceiver.

6. The transceiver according to claim 1, wherein the number of data packets to be stored by the one or more HARQ entities depends on the number of HARQ processes.

7. The transceiver according to claim 1, wherein the number of HARQ processes is:
limited by, e.g. seven or eight, as default; or
is reduced up to, e.g. four, when enabling dynamic determination of the number of HARQ processes based on the transmission parameter; or
is limited to the minimum of e.g. three; or
is limited by, e.g. 4 or 16, based on a transmission parameter.

8. The transceiver according to claim 1, wherein one or more HARQ entities are configured
to dynamically adapt the number of HARQ processes; and/or
to activate the determination or dynamic determination of the number of HARQ processes; or
to dynamically adapt the number of HARQ processes; and/or
to activate the determination or dynamic determination of the number of HARQ processes by configuration or as a part of the resource pool configuration.

9. The transceiver according to claim 1, wherein the one or more HARQ entities are configured to buffer the first data portion and/or further data portions and/or to retransmit the first data portion or a further data portion upon a respective feedback portion indicating an incorrect receipt of the first data portion.

10. The transceiver according to claim 9, wherein the retransmission of the first data portion is performed at a first retransmission time slot after the first subsequent timeslot.

11. The transceiver according to claim 1, wherein the transceiver is configured to transmit a second data portion by use of a sidelink at a second timeslot and to receive a corresponding feedback portion at a second subsequent timeslot.

12. The transceiver according to claim 1, wherein the transceiver is configured to transmit a further first data portion by use of a further sidelink to another further transceiver and to receive a further corresponding feedback portion indicating the correct/incorrect receipt of the further first data portion.

13. The transceiver according to claim 1, wherein case the one or more HARQ entities comprise no available HARQ process overwrites/flushes an existing HARQ process.

14. The transceiver according to claim 13, wherein the buffer to be overwritten/flushed is chosen by one or more of:
Lowest priority of a packet,
Source and/or destination ID,
Cast type,
Associated logical channel (LCH) or QoS flow,
Age of a data portion
Remaining packet delay budget,
Number of retransmissions,
Buffer size, e.g. delete large packet to free-up more soft buffer
e.g. transmission with many retransmissions.

15. A further transceiver comprising one or more HARQ entities, wherein the further transceiver is configured to receive a first data portion by use of a sidelink at a first timeslot and to transmit a corresponding feedback portion at a first subsequent timeslot within a resource pool using the one or more HARQ entities,
wherein the one or more HARQ entities are configured to determine the number of the HARQ processes used for a communication with another sidelink transceiver based on transmission parameters or configured grant configuration as part of the transmission parameters;
wherein the transmission parameters comprise feedback periodicity, minimum time gap between the first and subsequent time slots and/or a timeslot for the retransmission.

16. The further transceiver according to claim 15, wherein the one or more HARQ entities are configured to analyze the received first data portion with regard to its correct/incorrect/complete/incomplete receipt in order to determine the corresponding feedback portion.

17. A system comprising at least a transceiver comprising one or more HARQ entities;
wherein the transceiver is configured to transmit a first data portion by use of a sidelink at a first timeslot and to receive a corresponding feedback portion at a first subsequent timeslot within a resource pool using the one or more HARQ entities;
wherein the one or more HARQ entities are configured to determine the number of HARQ processes used for a communication with another sidelink transceiver based on transmission parameters, wherein the transmission parameters comprise feedback periodicity, minimum time gap between the first and subsequent time slots and/or a timeslot for the retransmission,
and a further transceiver comprising one or more HARQ entities, wherein the further transceiver is configured to receive a first data portion by use of a sidelink at a first timeslot and to transmit a corresponding feedback portion at a first subsequent timeslot within a resource pool using the one or more HARQ entities,
wherein the one or more HARQ entities are configured to determine the number of the HARQ processes used for a communication with another sidelink transceiver based on transmission parameters or configured grant configuration as part of the transmission parameters;
wherein the transmission parameters comprise feedback periodicity, minimum time gap between the first and subsequent time slots and/or a timeslot for the retransmission.

18. A method for determining the number of HARQ processes for a transceiver,
wherein the transceiver is configured to transmit a first data portion by use of a sidelink at a first timeslot and to receive a corresponding feedback portion at a first subsequent timeslot within a resource pool using the one or more HARQ entities, wherein the method comprises determining the number of HARQ processes used for a communication with another sidelink transceiver based on transmission parameters;
wherein the transmission parameters comprise feedback periodicity, minimum time gap between the first and subsequent time slots and/or a timeslot for the retransmission.

19. A method for determining the number of HARQ processes for a further transceiver, wherein the further transceiver is configured to receive a first data portion by use of a sidelink at a first timeslot and to transmit a corresponding feedback portion (indicating the correct/incorrect receipt of the first data portion) at a first subsequent timeslot within a resource pool using the one or more HARQ entities, the method comprising determining the number of HARQ processes used for a communication with another sidelink transceiver based on transmission parameters;
wherein the transmission parameters comprise feedback periodicity, minimum time gap between the first and subsequent time slots and/or a timeslot for the retransmission.
